(19) United States
(12) Patent Application Publication
(10) Pub. No.: US 2018/0307228 A1
(43) Pub. Date: Oct. 25, 2018

(54) Adaptive Autonomous Vehicle Driving Style

(71) Applicant: GM GLOBAL TECHNOLOGY OPERATIONS LLC, Detroit, MI (US)

(72) Inventors: Dustin H. Smith, Auburn Hills, MI (US); Timothy Grost, Clarkston, MI (US); Younghwa Yun, Troy, MI (US); Emily M. Bowman, Royal Oak, MI (US); Anna M. Wagner, Troy, MI (US)

(21) Appl. No.: 15/492,509

(22) Filed: Apr. 20, 2017

(51) Int. Cl. G05D 1/00; G05D 1/02

(52) U.S. Cl. CPC G05D 1/0088; G05D 1/021; G05D 1/0293

(57) ABSTRACT

A vehicle includes an actuator configured to control vehicle steering, acceleration, braking, or shifting. The vehicle additionally includes a vehicle control interface configured to control the actuator in response to user input. The vehicle further includes at least one controller. The controller is configured to automatically control the actuator based on an automated driving system algorithm. The controller is configured to, in response to receiving a learning mode activation input, monitor at least one user input to the vehicle control interface. The controller is further configured to generate a driving preference profile based on the monitored user input. The controller is further configured to receive a learning mode termination input, and subsequent the learning mode termination input, control the vehicle via the automated driving system in accordance with the driving preference profile.

### TECHNICAL FIELD

The present disclosure relates to vehicles controlled by automated driving systems, particularly those configured to automatically control vehicle steering, acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

A method of controlling a vehicle with an automated driving system includes receiving a learning mode activation input. The method additionally includes, in response to receiving the learning mode activation input, monitoring at least one user input to a vehicle control interface. The method also includes generating a driving preference profile based on the monitored user input. The method further includes receiving a learning mode termination, and subsequent the learning mode termination input, controlling the vehicle via the automated driving system in accordance with the driving preference profile.

In an exemplary embodiment, the learning mode activation input includes an initial use of the automated driving system.

In an exemplary embodiment, the user input to the vehicle control interface includes a user actuation of a steering input device, shifting device, braking device, or acceleration device.

In an exemplary embodiment, the method additionally includes, in response to receiving the learning mode activation input, monitoring at least one external vehicle sensor.

In an exemplary embodiment, the driving preference profile includes a preferred vehicle speed, a preferred acceleration rate, or a preferred following distance.

In an exemplary embodiment, the learning mode termination input includes an elapsed time subsequent the learning mode activation input exceeding a threshold, an elapsed mileage travelled subsequent the learning mode activation input exceeding a threshold, or a second driver input.

A vehicle according to the present disclosure includes an actuator configured to control vehicle steering, acceleration, braking, or shifting. The vehicle additionally includes a vehicle control interface configured to control the actuator in response to user input. The vehicle further includes at least one controller. The controller is configured to automatically control the actuator based on an automated driving system algorithm. The controller is configured to, in response to receiving a learning mode activation input, monitor at least one user input to the vehicle control interface. The controller is further configured to generate a driving preference profile based on the monitored user input. The controller is further configured to receive a learning mode termination input, and subsequent the learning mode termination input, control the vehicle via the automated driving system in accordance with the driving preference profile.

In an exemplary embodiment, the learning mode activation input includes an initial use of the automated driving system.

In an exemplary embodiment, the user input to the vehicle control interface includes a user actuation of a steering input device, shifting device, braking device, or acceleration device.

In an exemplary embodiment, the controller is further configured to, in response to receiving the learning mode activation input, monitoring at least one external vehicle sensor.

In an exemplary embodiment, the driving preference profile includes a preferred vehicle speed, a preferred acceleration rate, or a preferred following distance.

In an exemplary embodiment, the learning mode termination input includes an elapsed time subsequent the learning mode activation input exceeding a threshold, an elapsed mileage travelled subsequent the learning mode activation input exceeding a threshold, or a second driver input.

A method of controlling a fleet of autonomous vehicles according to the present disclosure includes providing a vehicle with an automated driving system and a vehicle control interface. The method additionally includes receiving a learning mode activation input associated the vehicle. In response to receiving the learning mode activation input, at least one user input to the vehicle control interface is monitored. The method also includes receiving a learning mode termination input, generating a driving preference profile based on the monitored user input, storing the driving preference profile in nontransient data memory, and controlling the vehicle via the automated driving system, subsequent the learning mode termination input, in accordance with the driving preference profile.

In an exemplary embodiment, the data memory is associated with a user mobile internet device.

In an exemplary embodiment, the method additionally includes controlling a second vehicle in accordance with the driving preference profile.

In an exemplary embodiment, the learning mode activation input includes an initial use of the automated driving system.

In an exemplary embodiment, the user input to the vehicle control interface includes a user actuation of a steering input device, shifting device, braking device, or acceleration device.

In an exemplary embodiment, the method additionally includes, in response to receiving the learning mode activation input, monitoring at least one external vehicle sensor.

In an exemplary embodiment, the driving preference profile includes a preferred vehicle speed, a preferred acceleration rate, a preferred turning rate, or a preferred following distance.

In an exemplary embodiment, the learning mode termination input includes an elapsed time subsequent the learning mode activation input exceeding a threshold, an elapsed mileage travelled subsequent the learning mode activation input exceeding a threshold, or a second driver input.

Embodiments according to the present disclosure provide a number of advantages. For example, the present disclosure provides a system and method for enabling a user of an autonomous vehicle to easily and intuitively define a desired driving style for the autonomous vehicle.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic view of a vehicle according to the present disclosure;

FIG. 2 is a schematic representation of a system for controlling a vehicle according to the present disclosure; and

FIG. 3 is a flowchart representation of a method according to the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

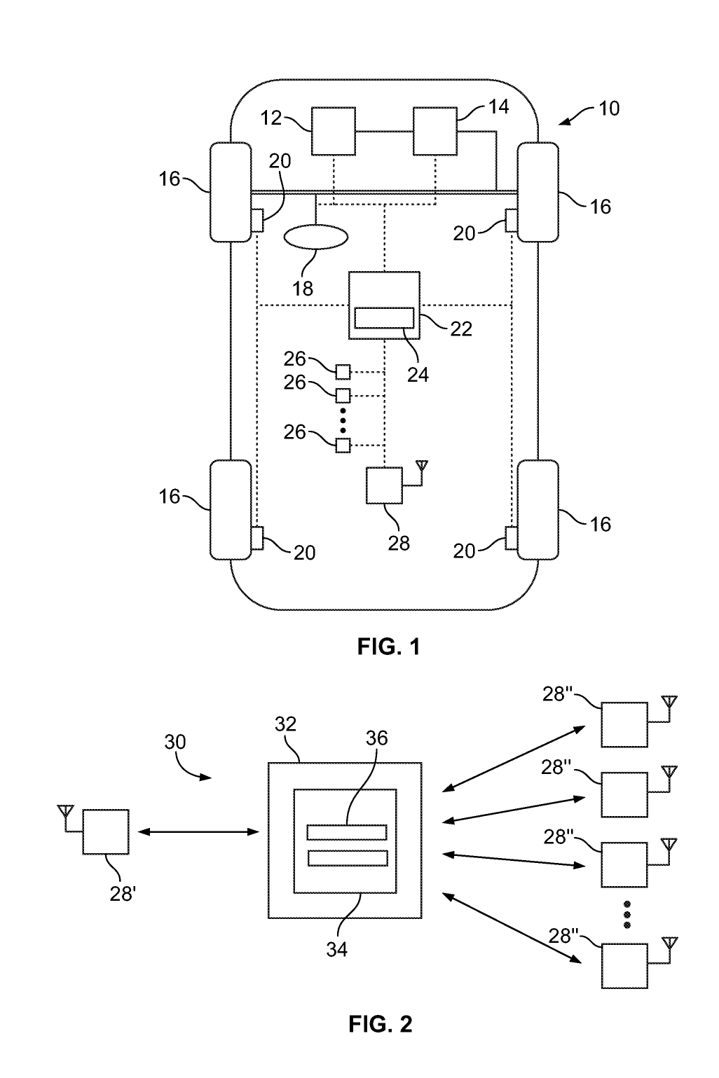

Referring now to FIG. 1, an automotive vehicle 10 according to the present disclosure is shown in schematic form. The automotive vehicle 10 includes a propulsion system 12, which may in various embodiments include an internal combustion engine, an electric machine such as a traction motor, and/or a fuel cell propulsion system.

The automotive vehicle 10 also includes a transmission 14 configured to transmit power from the propulsion system 12 to vehicle wheels 16 according to selectable speed ratios. According to various embodiments, the transmission 14 may include a step-ratio automatic transmission, a continuously-variable transmission, or other appropriate transmission.

The automotive vehicle 10 additionally includes a steering system 18. While depicted as including a steering wheel for illustrative purposes, in some embodiments contemplated within the scope of the present disclosure, the steering system 18 may not include a steering wheel.

The automotive vehicle 10 additionally includes a plurality of vehicle wheels 16 and associated wheel brakes 20 configured to provide braking torque to the vehicle wheels 16. The wheel brakes 20 may, in various embodiments, include friction brakes, a regenerative braking system such as an electric machine, and/or other appropriate braking systems.

The propulsion system 12, transmission 14, steering system 18, and wheel brakes 20 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 is provided with an automated driving system (ADS) 24 for automatically controlling various actuators in the vehicle 10. In an exemplary embodiment, the ADS 24 is configured to control the propulsion system 12, transmission 14, steering system 18, and wheel brakes 20 to control vehicle acceleration, steering, and braking, respectively, without human intervention.

The ADS 24 is configured to control the propulsion system 12, transmission 14, steering system 18, and wheel brakes 20 in response to inputs from a plurality of sensors 26, which may include GPS, RADAR, LIDAR, optical cameras, thermal cameras, ultrasonic sensors, and/or additional sensors as appropriate.

The vehicle 10 additionally includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, additional or alternate wireless communications standards, such as IEEE 802.11 and cellular data communication, are also considered within the scope of the present disclosure.

In an exemplary embodiment, the ADS 24 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. However, aspects of the present disclosure may be implemented in vehicles having lower-level automated driving systems.

Referring now to FIG. 2, an embodiment of a system 30 for controlling a vehicle is shown. The system 30 includes a wireless communication device 28′. In an exemplary embodiment, the wireless communication device 28′ is associated with an autonomous vehicle arranged generally similar to the vehicle 10 as shown in FIG. 1 and discussed above.

The wireless communication device 28′ is in communication with at least one remote server 32. In an exemplary embodiment, the wireless communication device 28′ is configured to wirelessly communicate with the server 32, e.g. via cellular data communication or other appropriate wireless communication protocols.

The wireless communication device 28″ is configured to communicate information to the server 32. The server 32 includes at least one computer readable storage device 34. The server 32 may include a microprocessor or central processing unit (CPU) in communication with the computer readable storage device 34. The computer readable storage device 34 is provided with data 36, e.g. in the form of one or more databases, including a traffic control device database having a list of known traffic control devices and associated intersection positions.

In an exemplary embodiment, the data 36 includes a secure user profile database for storing various information associated with one or more users, which may be referred to as user profiles. A user profile may include, for example, frequent destinations for the user, user payment information, or other relevant information. The user profile may also include a driving style profile, as will be discussed in further detail below.

A plurality of additional wireless communication devices 28″ are also in communication with the server 32. The additional wireless communication devices 28″ are configured to receive information from the server 32, e.g. by accessing the databases 36 or by having information “pushed” from the server 32 to the additional wireless communication devices 28″. In an exemplary embodiment, the plurality of additional wireless communication devices 28″ are coupled to a plurality of additional vehicles.

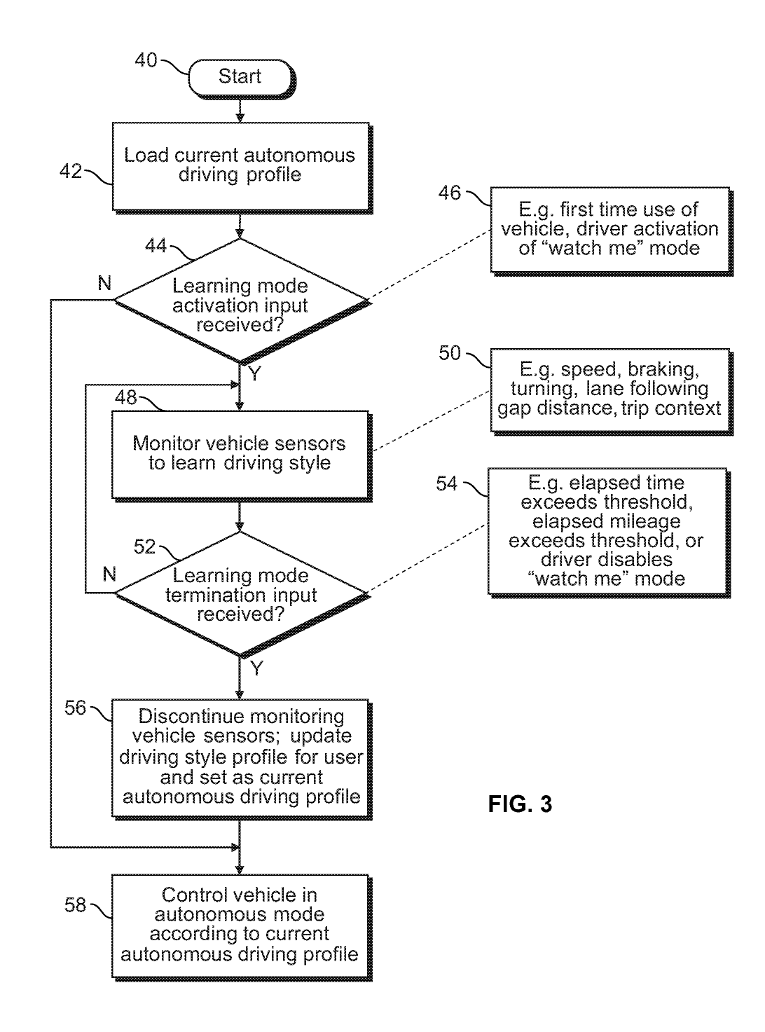

Referring now to FIG. 3, a method of controlling a vehicle according to the present disclosure is illustrated in flowchart form. The algorithm begins at block 40.

A current autonomous driving profile is loaded, as illustrated at block 42. The autonomous driving profile includes operating parameters within which the automated driving system operates. Such parameters may include acceleration rate targets for throttle applications, deceleration rate targets for braking applications, lateral acceleration rate targets for turning applications, and following distance targets for following other vehicles. Other applicable parameters may also be included. The current autonomous driving profile may, for example, be a default profile supplied by a vehicle manufacturer, a modified profile provided by a third party, or a customized driving style profile defined by the user according to the method described below.

A determination is made of whether a learning mode activation input is received, as illustrated at operation 44. The learning mode activation input indicates a user's desire to modify the current autonomous driving profile. The learning mode activation input may, for example, be a user activation of the learning mode, e.g. by selecting a “watch me” mode via a human-machine interface, as illustrated at block 46. As another example, a user may be prompted to activate the learning mode upon an initial use of a vehicle, and the learning mode activation input is received based on an affirmative response from the user, as also illustrated at block 46.

If the determination of operation 44 is positive, i.e. a learning mode activation input is received, then vehicle sensors are monitored to learn a user's desired driving style, as illustrated at block 48. The vehicle sensors include those associated with a vehicle control interface, such as a steering wheel angle sensor, an acceleration pedal sensor, a brake pedal sensor, and a shifter position sensor. The sensors also include those associated with a region external the vehicle, such as optical cameras, LiDAR, ultrasonic sensors, or other sensors arranged to detect external features in the vicinity of the vehicle.

In some embodiments, e.g. autonomous vehicles having no conventional user input such as a steering wheel, accelerator pedal, or brake pedal, the vehicle control interface may include a voice-control interface via a microphone in the vehicle or on a mobile device. In such embodiments a user may provide vocal commands to modify vehicle behavior, e.g. by instructing the vehicle to accelerate more slowly, brake earlier, or turn more rapidly. Other interfaces by which a user may provide feedback on driving style, such as virtual reality, may also be provided.

Signals received from the monitored sensors may be used to learn a user's desired driving style, including preferred driving speed, preferred braking rate, preferred acceleration rate, preferred turning rate, and preferred following distance for following other vehicles, as illustrated at block 50. Moreover, contextual information such as date and time, location, weather, number of vehicle occupants, traffic conditions, and any other available user information may also be recorded and associated with the monitored data.

A determination is then made of whether a learning mode termination input is received, as illustrated at operation 52. The learning mode termination input indicates a desire to end the monitoring period. The learning mode termination input may, for example, be a user termination of the learning mode, e.g. by making a selection via a human-machine interface, as illustrated at block 54. As another example, the learning mode termination input may be triggered upon an elapsed time subsequent the learning mode activation input exceeding a threshold, or upon an elapsed mileage subsequent the learning mode activation input exceeding a threshold, as also illustrated at block 54.

If the determination of operation 52 is negative, i.e. no learning mode termination input is received, then control returns to block 48. Thus, the vehicle sensors are monitored until the learning mode termination input is received.

If the determination of operation 52 is positive, i.e. the learning mode termination input is received, then the monitoring of vehicle sensors is discontinued, as illustrated at block 56. A driving style profile for the user is updated and set as the current autonomous driving profile, as also illustrated at block 56. As described above, autonomous driving profile includes operating parameters within which the automated driving system operates, such as acceleration rate targets for throttle applications, deceleration rate targets for braking applications, lateral acceleration rate targets for turning applications, and following distance targets for following other vehicles. The updated driver profile may be stored both locally, e.g. in data storage of the vehicle 10, and also in a user profile in a secure user profile database as discussed above with respect to FIG. 2.

In an exemplary embodiment, each user-modifiable operating parameter is provided with a maximum and minimum allowable value. Vehicle braking, acceleration, turning, and following distance may thereby be maintained within desirable limits during autonomous operation. In some embodiments, the vehicle may provide feedback to an operator in response to operator inputs falling outside of the allowed range.

The vehicle is subsequently controlled in autonomous mode according to the current autonomous driving profile, as illustrated at block 58. Thus, the autonomous behavior of the vehicle 10 may be customized based on guidance from the operator.

Returning to operation 44, if the determination is negative, i.e. no learning mode activation input is received, control proceeds to block 58 and the vehicle is subsequently controlled in autonomous mode according to the current autonomous driving profile. Thus, the autonomous behavior of the vehicle is based on the current autonomous driving profile until the learning mode is activated.

In some embodiments, an autonomous driving profile may be defined by a third party, i.e. a party other than the user or manufacturer. Such third-party autonomous driving profiles may be made available by the third party and set as the current autonomous driving profile for a given vehicle with consent of the user.

As may be seen the present disclosure provides a system and method for operating an autonomous vehicle in accordance with preferences of users, thereby increasing user satisfaction. Users may furthermore impart their preferences to the autonomous vehicle in an easy and intuitive manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of controlling a vehicle with an automated driving system, the method comprising:
receiving a learning mode activation input;
in response to receiving the learning mode activation input, monitoring at least one user input to a vehicle control interface;
generating a driving preference profile based on the monitored user input;
receiving a learning mode termination input; and
controlling the vehicle via the automated driving system, subsequent the learning mode termination input, in accordance with the driving preference profile.

2. The method of claim 1, wherein the learning mode activation input includes an initial use of the automated driving system.

3. The method of claim 1, wherein the user input to the vehicle control interface includes a user actuation of a steering input device, shifting device, braking device, or acceleration device.

4. The method of claim 1, further comprising, in response to receiving the learning mode activation input, monitoring at least one external vehicle sensor.

5. The method of claim 1, wherein the driving preference profile includes a preferred vehicle speed, a preferred acceleration rate, a preferred turning rate, or a preferred following distance.

6. The method of claim 1, wherein the learning mode termination input includes an elapsed time subsequent the learning mode activation input exceeding a threshold, an elapsed mileage travelled subsequent the learning mode activation input exceeding a threshold, or a second driver input.

7. A vehicle comprising:
an actuator configured to control vehicle steering, acceleration, braking, or shifting;
a vehicle control interface configured to control the actuator in response to user input; and
at least one controller configured to automatically control the actuator based on an automated driving system algorithm, the at least one controller being configured to, in response to receiving a learning mode activation input, monitor at least one user input to the vehicle control interface, generate a driving preference profile based on the monitored user input, receive a learning mode termination input, and control the vehicle via the automated driving system, subsequent the learning mode termination input, in accordance with the driving preference profile.

8. The vehicle of claim 7, wherein the learning mode activation input includes an initial use of the automated driving system.

9. The vehicle of claim 7, wherein the user input to the vehicle control interface includes a user actuation of a steering input device, shifting device, braking device, or acceleration device.

10. The vehicle of claim 7, wherein the controller is further configured to, in response to receiving the learning mode activation input, monitor at least one external vehicle sensor.

11. The vehicle of claim 7, wherein the driving preference profile includes a preferred vehicle speed, a preferred acceleration rate, or a preferred following distance.

12. The vehicle of claim 7, wherein the learning mode termination input includes an elapsed time subsequent the learning mode activation input exceeding a threshold, an elapsed mileage travelled subsequent the learning mode activation input exceeding a threshold, or a second driver input.

13. A method of controlling a fleet of autonomous vehicles, the method comprising:
providing a vehicle having an automated driving system and a vehicle control interface;
receiving a learning mode activation input associated the vehicle;
in response to receiving the learning mode activation input, monitoring at least one user input to the vehicle control interface;
receiving a learning mode termination input;
generating a driving preference profile based on the monitored user input;
storing the driving preference profile in nontransient data memory; and
controlling the vehicle via the automated driving system, subsequent the learning mode termination input, in accordance with the driving preference profile.

14. The method of claim 13, wherein the data memory is associated with a user mobile internet device.

15. The method of claim 13, further comprising controlling a second vehicle in accordance with the driving preference profile.

16. The method of claim 13, wherein the learning mode activation input includes an initial use of the automated driving system.

17. The method of claim 13, wherein the user input to the vehicle control interface includes a user actuation of a steering input device, shifting device, braking device, or acceleration device.

18. The method of claim 13, further comprising, in response to receiving the learning mode activation input, monitoring at least one external vehicle sensor.

19. The method of claim 13, wherein the driving preference profile includes a preferred vehicle speed, a preferred acceleration rate, a preferred turning rate, or a preferred following distance.

20. The method of claim 13, wherein the learning mode termination input includes an elapsed time subsequent the learning mode activation input exceeding a threshold, an elapsed mileage travelled subsequent the learning mode activation input exceeding a threshold, or a second driver input.
